(19) United States
(12) Patent Application Publication
(10) Pub. No.: US 2019/0074013 A1
(43) Pub. Date: Mar. 7, 2019

(54) METHOD, DEVICE AND SYSTEM TO FACILITATE COMMUNICATION BETWEEN VOICE ASSISTANTS

(71) Applicant: Intel Corporation, Santa Clara, CA (US)

(72) Inventor: Sean J.W. LAWRENCE, Bangalore (IN)

(73) Assignee: Intel Corporation, Santa Clara, CA (US)

(21) Appl. No.: 16/179,653

(22) Filed: Nov. 2, 2018

(51) Int. Cl. G10L 15/32; G10L 15/22; G10L 15/30

(52) U.S. Cl. CPC G10L 15/32; G10L 2015/223; G10L 15/30; G10L 15/22

(57) ABSTRACT

Techniques and mechanisms for a first voice assistant to automatically participate in speech communication with a second voice assistant. In an embodiment, circuitry of a first device provides an input and/or output (IO) interface of the first voice assistant, and detects a first utterance spoken by a participant in a conversation. Based on an analysis of the first utterance, the device detects a pendency of a first request of the conversation. A second utterance of the first voice assistant is automatically generated by the device based on the pendency of the first request and a detected availability of the second voice assistant. The second utterance represents a second request which comprises a handle to address the second voice assistant. In another embodiment, the handle is generated automatically based on profile information which describes (or is otherwise associated with) a characteristic of the second voice assistant.

### BACKGROUND

### 1. Technical Field

This disclosure generally relates to voice assistant technology and more particularly, but not exclusively, to automatic audio communication between voice assistants.

### 2. Background Art

Voice assistants (also known as “virtual assistants” or “knowledge navigators”) variously support audio communication between a human user and an artificial intelligence (AI) or other suitable resource which facilitates a data search or other such task. Examples of existing voice assistant technologies include Siri® developed by Apple Incorporated of Cupertino, Calif., and Cortana™ developed by the Microsoft Corporation of Redmond, Wash. Other examples include Bixby™ developed by Samsung Electronics of Seoul, South Korea, Google Assistant™ developed by Google, LLC of Mountain View, Calif. and Alexa™ developed by Amazon.com, Incorporated of Seattle, Wash.

Successive improvements to hardware and software continue to enable voice assistant solutions with smaller form factors, faster processing speeds, higher communication bandwidths, and better voice recognition. As a result, the number and variety of these solutions is expected to increase in the coming years, as is the demand for developments which enable more efficient use of voice assistant technologies.

### BRIEF DESCRIPTION OF THE DRAWINGS

The various embodiments of the present invention are illustrated by way of example, and not by way of limitation, in the figures of the accompanying drawings and in which:

FIG. 1A is a functional block diagram illustrating elements of a system to facilitate communication between voice assistants according to an embodiment.

FIG. 1B is a functional block diagram illustrating elements of a device to provide communication with a voice assistant according to an embodiment.

FIG. 2A is a flow diagram illustrating elements of a method of communication with a voice assistant according to an embodiment.

FIG. 2B is a flow diagram illustrating elements of a method for determining a handle to communicate with a voice assistant according to an embodiment.

FIGS. 3 through 7 are swim-lane diagrams each illustrating elements of a respective exchange including audio communication between voice assistants according to a corresponding embodiment.

FIG. 8 is a functional block diagram illustrating a computing device in accordance with one embodiment.

FIG. 9 is a functional block diagram illustrating an exemplary computer system, in accordance with one embodiment.

### DETAILED DESCRIPTION

Embodiments discussed herein variously provide techniques and mechanisms for a voice assistant, provided with one device, to participate in audio communication with a second voice assistant. In some embodiments, the audio communication is based on an automatic generation of a handle with which one voice assistant is to address the other voice assistant.

As used herein, “voice assistant” (also known as “virtual assistant” or “knowledge navigator”) refers to an agent which includes an audio input and/or output (IO) interface to receive spoken queries, commands and/or other communications, and to provide audio responses to such communications. Using such an IO interface, functionality of a voice assistant enables a user to search, execute, update, or otherwise access memory, processor and/or other resources which, for example, are resident on a device which provides the audio IO interface. Some or all such resources may, alternatively, be remote from the device, but accessible to the device via one or more wired networks and/or one or more wireless networks. Examples of voice assistant functionality which may be adapted according to some embodiments include, but are not limited to, that provided by Siri®, Alexa™, Cortana™, Bixby™, or Google Assistant™.

Unless otherwise indicated, “conversation” refers herein to a spoken exchange in which multiple speakers variously participate each with a respective audio communication. The term “utterance” refers herein to an instance of speech by a given speaker—e.g., including natural speech by a human or synthetic speech such as that output by an IO interface of a voice assistant. A given utterance can include a question, a statement (e.g., including a response to a question), or a voiceprint sample, for example. As described herein, some utterances specify or otherwise indicate that a voice assistant is authorized to access a given resource or, for example, that the voice assistant is to provide such resource access to another voice assistant.

A source of a given utterance is referred to herein as a “speaker” of the utterance. Under certain conditions, a speaker is determined to be a “participant” in a conversation—e.g., where the utterance is determined to be in response to, or otherwise addressing, another conversation participant. A given participant may be a voice assistant or a user of said voice assistant, where in this context (unless otherwise indicated) “user” refers herein to a human. For example, a user of a voice assistant can include an owner or other authorized operator of a device which includes hardware logic and/or software logic to provide an IO interface of the voice assistant.

Some embodiments variously provide a voice assistant which is operable to determine a state of a conversation and, based on said state, to generate an utterance to communicate with another voice assistant. As used herein, a “state” of a conversation (or “conversation state”) refers to any of various characteristics of one or more participants in and/or utterances of that conversation. For example, conversation state may include a current one or more participants in a conversation, an utterance type (e.g., comment, command, command response or the like) of a given utterance, whether a response to a given utterance has been detected, a type of voice assistant, a type of device which provides an IO interface of a voice assistant, or the like. Conversation state may additionally or alternatively include a context in which a conversation takes place.

In an example embodiment, an utterance includes a handle that is automatically generated based on a state of the conversation—e.g., where the state includes one of a user of a voice assistant, an identified type of a voice assistant, an identified type of a device which provides an IO interface of the voice assistant, or the like. The term “handle” refers herein to a string of characters (or a sound which represents the string) which, for example, includes one or more words, initials and/or other information to signify a particular participant—e.g., where a given utterance includes the handle to indicate that said utterance is addressed to a particular voice assistant (or alternatively, to a particular user). Conventional voice assistants are variously configured each to respond to a respective generic handle which is chosen for their corresponding voice assistant type/class. For example, all Siri® voice assistants respond to (are addressed by) “Hey Siri,” all Alexa™ voice assistants respond to “Alexa,” and all Google Assistant™ voice assistants respond to “OK Google.” While variously enabling voice assistants to participate in conversation—e.g., including enabling automatic speech communication between voice assistants—some embodiments more particularly generate a handle to mitigate the possibility of confusion or ambiguity during such conversation. For example, some embodiments enable automatic generation of a handle to the addressing of a voice assistant using an automatically-generated handle other than any generic handle corresponding to a generic (e.g., a proprietary) voice assistant type/class.

Certain features of various embodiments are described herein with reference to the automatic generation of an utterance and/or a handle to be used in communication with a voice assistant. In this particular context, “automatic” refers herein to the characteristic of the utterance and/or handle (“utterance/handle”) being generated by a device independent of that device receiving any command to communicate the utterance/handle, where the command explicitly specifies the utterance/handle. In an embodiment, such automatic generating is responsive to an earlier-in-time utterance, and is based on predefined reference information (or other configuration state) which is provided at, or otherwise accessible to, the device prior to the device detecting said earlier-in-time utterance. Such configuration state specifies or otherwise indicates one or more rules, templates, schema and/or other fiducial information to apply—e.g., for the device to determine one or more words to be included in (or excluded from) the utterance/handle, to determine a modification to be made to a given word, and/or to determine an order of words in a word sequence of the utterance/handle. At the time of the device detecting the earlier-in-time utterance, the utterance/handle to be generated may be as-yet undetermined, and/or may be subject to an evaluation by the device as to whether the utterance/handle is to be modified, to be selected from among multiple candidate utterances/handles, or the like. In one such embodiment, the automatically generated utterance/handle includes more, fewer, different and/or differently ordered words, as compared to the words of the earlier-in-time utterance and/or another earlier-in-time utterance of the conversation (if any) which is an at least partial basis of the automatic generation.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion. It is pointed out that those elements of the figures having the same reference numbers (or names) as the elements of any other figure can operate or function in any manner similar to that described, but are not limited to such.

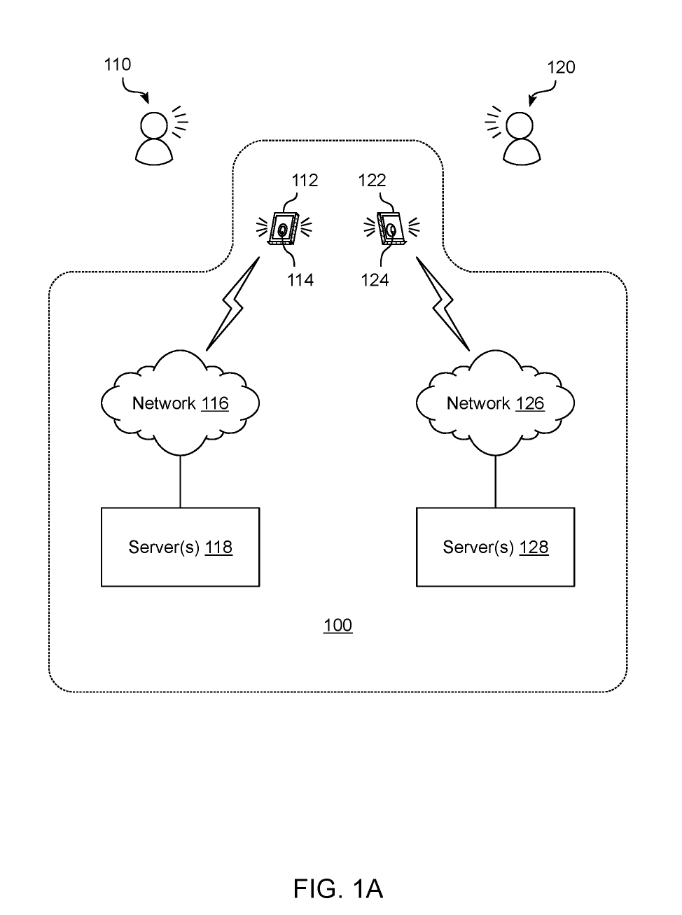

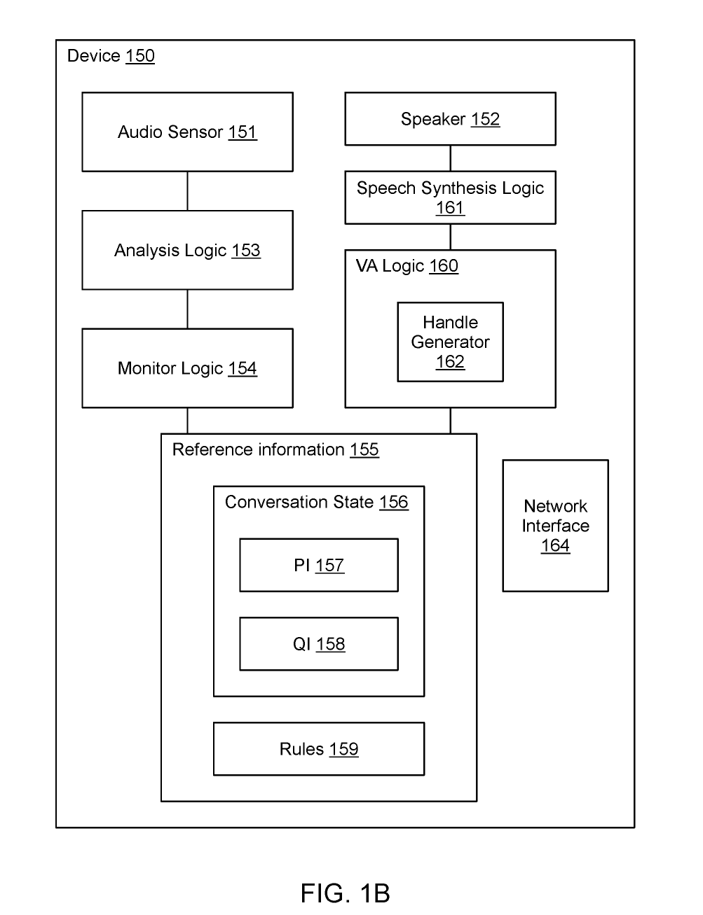

FIG. 1A shows features of a system 100 to facilitate communication between voice assistants according to an embodiment. System 100 is one example of an embodiment wherein devices are variously configured each to provide access to respective voice assistant (VA) functionality, wherein logic included in or otherwise accessible by one such device (e.g., the logic including circuit hardware and/or executing software) facilitates automatic audio communication by one voice assistant with one or more other voice assistants.

For example, as shown in FIG. 1A, system 100 includes at least two devices 112, 122 which are configured to provide access to respective voice assistants (such as the illustrative VAs 114, 124). Either of devices 112, 122 may be any of various types of devices—such as a smartphone, tablet, laptop computer, desktop computer, dedicated virtual assistant device, smart appliance (e.g., a refrigerator, dish washer, laundry machine, etc.), or the like—which includes circuitry to provide access to voice assistant functionality. Some or all such voice assistant functionality may be implemented locally at such a device, or implemented in part with resources which are accessible to the device via one or more networks. Alternatively or in addition, such voice assistant functionality may be used to access resources (e.g., memory, processing, communication bandwidth or the like) which are local to the device and/or to access other resources via one or more networks. Such resources may facilitate data searching, calendar scheduling, event notification, online purchasing and/or any of a variety of use cases with one of VAs 114, 124.

In the example shown, a user 110 is authorized to use VA 114, and another user 120 is authorized to use VA 124—e.g., where user 110 is an owner and/or other operator of device 112 and/or user 120 is an owner/operator of device 122. However, in an alternate scenario, only one user operates system 100 at some particular time—e.g., where only one of users 110, 120 is present and authorized to interact with VAs 114, 124. With VA 114, a user is able to access resources at device 112 and/or is able to access one or more servers 118 via a network 116. Similarly, with VA 124, the same user or another user is able to access resources at device 122 and/or is able to access one or more servers 128 via a network 126. Network 116 or network 126 may include any of a variety of one or more wired networks and/or one or more wireless networks. By way of illustration and not limitation, networks 116, 126 may include a local area network (LAN), a wide area network (WAN), a virtual LAN (VLAN), a metropolitan area network (MAN), a cellular network and/or the like.

In an embodiment, device 112 includes, or otherwise provides access to, logic which automatically generates an utterance of VA 114, where such utterance is for audio communication with VA 124. Alternatively or in addition, device 122 may provide access to logic which automatically generates an utterance of VA 124 for audio communication with VA 114. With reference to device 112, for example, automatic audio communication with VA 114 may include or otherwise be based on logic which detects and performs analysis of one or more utterances—e.g., including speech analysis to identify spoken words and/or voice analysis to identify a speaker's voice pattern. Based on such analysis, the logic determines information describing (e.g., including words communicated by) a given utterance. By way of illustration and not limitation, such information may include an identifier of a speaker of an utterance, an identifier of one or more participants being addressed by an utterance, whether or not an utterance includes a particular type of expression (e.g., a statement, a question, a response, or the like), and/or other such characteristics. In some embodiments, the analysis determines whether the voice assistant (e.g., VA 114) is being addressed by a given utterance. Alternatively or in addition, VA 114 may determine, for example, whether a request remains pending after such an utterance—e.g., where the utterance includes said request, or where a response (if any) to said request has yet to be provided as of the utterance.

In an embodiment, VA 114 performs or otherwise operates based on a monitoring of a conversation between multiple participants—e.g., where the conversation is with user 110 and one of (or both of) user 120 or VA 124. Such monitoring may include maintaining or otherwise determining information which describes a current state of the conversation—e.g., where the state information identifies one or more participants in the conversation and/or an availability of some other voice assistant to be accessed via audio communication.

Based on analysis of a given utterance, VA 114 may automatically generate, based on a pendency of an information request and an availability of another voice assistant (e.g., VA 124), another utterance which, for example, represents another request based on a currently pending request. This other utterance may include a handle to address the other voice assistant and/or may include another portion (e.g., comprising a search term, an instruction or the like) which is based on the pending request.

FIG. 1B shows features of a device 150 to participate in audio communication between voice assistants according to an embodiment. Device 150 is one example of an embodiment which includes or otherwise provides access to a first voice assistant, operation of which is to automatically generate an utterance for communication with a second voice assistant. The utterance may be generated based on a state of a conversation with a user of the first voice assistant. Device 150 may include some or all of the features of device 112 or device 114, for example.

As shown in FIG. 1B, device 150 includes an audio sensor 151 to detect sound in an environment near device 150. Analysis logic 153 of device 150 is coupled to audio sensor 151, the analysis logic 153 to detect whether such sound includes any of a variety of speech characteristics. Device 150 further comprises monitor logic 154 coupled to receive an output from analysis logic 153 and to identify, based on such speech characteristics, a state of a conversation (if any) which is taking place. For example, monitor logic 154 may update and/or otherwise access reference information 155—which is included in or otherwise accessible to device 150—to track a current state 156 of a conversation.

In such an embodiment, VA logic 160 of device 150 may have access to such reference information 155—e.g., where VA logic 160 is to identify, based on conversation state 156, whether device 150 is to output an utterance which addresses a current (or potential) participant in the conversation. For example, VA logic 160 may determine a sequence of words to be included in such an utterance, and may signal speech synthesis logic 161 of device 150 to generate signaling which represents such a sequence of words. The signaling from signal speech synthesis logic 161 may result in a communication of the utterance from device 150—e.g., via the illustrative speaker 152 shown.

In some embodiments, functionality of analysis logic 153 and/or monitor logic 154 is to “passively” detect for an instance of a conversation and/or a change to a state of said conversation—e.g., wherein such detecting is performed automatically as a background process independent of any explicit instruction from a user at the time of a conversation. Alternatively, the detecting may be in response to an explicit voice command, or other user input, indicating that a conversation is to begin or is taking place.

Various embodiments are described herein with reference to functionality, provided locally at device 150, which facilitates automatic communication between voice assistants. In alternative embodiments, some portion of such functionality may instead be implemented remotely from device 150—e.g., wherein device 150 accesses such functionality via a network using a network interface 164 thereof (e.g., the network interface 164 including a network interface card or other such hardware). For example, some functionality of analysis logic 153, monitor logic 154, reference information 155, VA logic 160 and/or speech synthesis logic 161 may be implemented at one or more remote servers which device 150 is to access via network interface 164.

In an example scenario according to one embodiment, audio sensor 151 includes one or more microphones to variously detect one or more utterances in a nearby environment. One such utterance may, for example, include a handle to address a first voice assistant which is provided with device 150. Analysis logic 153 may operate to detect such addressing of the first voice assistant.

For example, analysis logic 153 may include any of various types of suitable hardware and/or executing software which is adapted to process an audio input received by audio sensor 151, and to detect whether said audio input includes a representation of an utterance. Such detection may include one or more operations which, for example, are adapted from conventional speech recognition techniques (which are not detailed herein to avoid obscuring certain features of various embodiments).

In some embodiments, analysis logic 153 includes or otherwise has access to configuration state (e.g., including reference information stored in a memory, training state of one or more neural networks and/or the like) which is to facilitate the identification of one or more characteristics of an utterance. Such configuration state may specify or otherwise indicate one or more rules, templates, schema and/or other fiducial information which provides a basis for identifying and evaluating speech characteristics. For example, such fiducial information may include or otherwise indicate reference phonemes, words, grammatical rules, sentence structures, rhetorical relations, inflection characteristics, or the like. In some embodiments, such fiducial information further comprises biometric information for use in classifying a voice pattern of an utterance and, in some embodiments, for corresponding one or more particular voice patterns each with a respective previously-identified speaker.

Based on such configuration state, analysis logic 153 may classify at least some portion of an utterance as belonging to a particular utterance type of multiple predefined utterance types. For example, analysis logic 153 may identify a sequence of words of an utterance and grammatically parse the sequence to identify various parts of speech thereof (e.g., to identify one or more of a verb, noun, adverb, adjective, or the like). Accordingly, the sequence of words may be analyzed to identify, for example, whether the utterance is one of an information request type, a statement type, a command type, a response type (e.g., an error message type) or any of various other predefined utterance types. Such analysis may further classify, tag or otherwise identify one or more terms and/or actions which are referenced in the sequence. For example, one or more terms may include one or more of a participant (actual or prospective) being addressed by the utterance, an authorization being requested or approved by the utterance, a parameter of a command to perform a data search or other action, and/or the like. In addition to the analysis of a sequence of words in an utterance, analysis logic 153 may further perform processing to identify a voice pattern of the utterance. In some embodiments, analysis logic 153 may determine, based on such a voice pattern, whether a speaker of the utterance has been previously identified by device 150.

Monitor logic 154 includes any of various types of suitable hardware and/or executing software which are adapted to identify a state of a conversation based on words and/or other speech characteristics of an utterance detected by analysis logic 153. In some embodiments, monitor logic 154 detects a dialectical (or other) relationship between two utterances—e.g., including determining that one utterance includes a response to a command or request communicated by another utterance. Monitor logic 154 identifies, for example, that a request communicated in one utterance is pending—e.g., until some later utterance communicates a response to the request which is satisfactory, according to some predetermined criteria. In some embodiments, monitor logic 154 determines whether or not a speaker of an utterance (and/or an actual or potential participant addressed by such an utterance) has been previously identified by device 150.

Reference information 155 is one example of configuration state of device 150 which is to serve as a basis for determining an utterance to be generated—e.g., to facilitate communication between two voice assistants. Reference information 155 may provide any of a variety of one or more rules, templates, conditions, criteria, parameters, threshold values, other bases for determining a state of a conversation and/or generating an utterance based on such state. In various embodiments, one or more such bases are implemented with training state of a neural network which, for example, is included in or otherwise accessible to device 150.

Monitor logic 154 accesses reference information 155 for use in evaluating words and/or other speech characteristics of an utterance. In some embodiments, monitor logic 154 updates reference information 155, based on such evaluating, to maintain up-to-date state information (such as the illustrative conversation state 156 shown). VA logic 160 may access reference information 155 to determine—e.g., based on conversation state 156—an utterance (if any) to be communicated from device 150.

In the illustrative embodiment shown, rules 159 of reference information 155 specify or otherwise indicate criteria for determining a state of a conversation. For example, rules 159 (or other such reference information) indicate criteria for determining whether a particular speaker is—or is not—a participant in a given conversation. Such conditions include, for example, one or more of a threshold period of time since a most recent utterance by a speaker, a threshold period of time since a most recent reference to the speaker by another participant, and/or a predefined statement, keyword, term, etc. indicating a speaker's departure from a conversation. Alternatively or in addition, rules 159 (or other such reference information) may indicate criteria for determining that some first utterance is in response to, or otherwise relates to, an earlier-in-time second utterance. Examples of such criteria include a similarity between respective words of the first utterance and the second utterance, a speaker of the first utterance being addressed by the second utterance, a threshold period of time between the first utterance and the second utterance, or the like. In some embodiments, rules 159 (or other such reference information) provide one or more templates or other criteria for determining, based on an utterance, that an access right is extended to a voice assistant or, for example, that the voice assistant is to provide an access right to another voice assistant.

In an embodiment, monitor logic 154 applies one or more rules, templates, or other reference information to determine that an utterance is of a predefined utterance type (e.g., one of multiple possible utterance types). For example, a given utterance may be classified as including one of an information request, a statement, an answer, an error message, or the like. Alternatively or in addition, monitor logic 154 may determine whether—according to predefined voice recognition criteria—a voice pattern of a given utterance is that of a previously identified participant. Based on such characteristics of a given utterance, monitor logic 154 updates conversation state 156 and, in some embodiments, other data of reference information 155.

For example, monitor logic may create, update or otherwise access participant information PI 157 which describes one or more current participants in the conversation. PI 157 includes, for each of one or more participants, respective profile information which identifies the participant or otherwise describes characteristics associated with the participant. For example, profile information for a given participant may include one or more of a name (or other identifier) of the participant, a user type identifier indicating whether the participant is a user or a voice assistant, a resource access right which is allocated to the participant, a voice pattern of the participant, and/or the like. Where a participant is a voice assistant, profile information for the participant may further include an identifier of an authorized user of the voice assistant, a device type of a device which provides the voice assistant, a general voice assistant type/class to which voice assistant belongs, and/or the like. Where a participant is a user, profile information for the participant may further include an identifier of a voice assistant which is associated with the participant.

In some embodiments, monitor logic 154 further identifies an information request, communicated by some utterance, as being pending—e.g., until a satisfactory response to the information request (according to some predetermined criteria) is detected in some later utterance. Accordingly, updates and/or other accesses to conversation state 156 may additionally or alternatively include monitor logic 154 creating, changing or otherwise determining information QI 158 which describes an as-yet-still-pending request communicated by an utterance. In some embodiments, QI 158 specifies or otherwise indicates one or more search terms, parameters and/or other items which analysis logic 153 detects in said utterance. In one such embodiment, QI 158 further identifies a speaker of said utterance and/or a participant which is addressed by the utterance. In response to detecting that some utterance includes a satisfactory response to a request communicated in an earlier-in-time utterance, monitor logic 154 updates QI 158 to remove any indication that the request is currently pending.

Based on conversation state 156, VA logic 160 determines at some point that a first voice assistant, provided by device 150, has been addressed by (and/or is able to service) a request which, according to QI 158, is currently pending. In an embodiment, VA logic 160 includes the first voice assistant, for example, or otherwise provides an audio IO interface of the first voice assistant. VA logic 160 further provides functionality to determine—e.g., based on PI 157—that, during such request pendency, a second voice assistant is currently available for communication via speech communication.

For example, PI 157 (or other information of conversation state 156) may specify or otherwise indicate that the second voice assistant has a resource access right which facilitates a servicing of a currently pending request. In an embodiment, a user account, device type, or other characteristic (associated with the second voice assistant) corresponds to an accessibility—via the second voice assistant—of a particularly relevant memory resource, network service or the like. Embodiments variously enable the first voice assistant to avail of such accessibility using speech communication between the first voice assistant and the second voice assistant.

For example, based on the pendency of a request and an availability of a second voice assistant via speech communication, VA logic 160 generates, selects or otherwise determines a sequence of words to be represented in an utterance by device 150. Such a sequence of words includes, for example, a handle to indicate that the utterance is to address the currently-available second voice assistant.

In an example scenario according to one embodiment, VA logic 160 includes or otherwise has access to a handle generator 162, comprising any of various types of suitable hardware and/or executing software adapted to generate a handle based on conversation state 156. In one embodiment, the handle generator 162 includes or otherwise has access to profile information associated with the second voice assistant (e.g., at PI 157), which is used to determine the handle. For example, a profile for the second voice assistant may include some or all of the information in Table 1 below:

TABLE 1
Example Profile Information for a Voice Assistant.

| Variable | Notes |
|---|---|
| user_id | an identifier of an authorized user of the voice assistant |
| user_name | a name currently designated for addressing the user |
| | identified by user_id |
| device_type | a type of a device - e.g., one of a smartphone, tablet, |
| | smart speaker, smartwatch, or the like - which |
| | provides an audio IO interface of the voice assistant |
| VA_gen | a generic type of the voice assistant - e.g., one of Siri, |
| | Alexa, Google Assistant, Cortana, Bixby, or the like |
| VA_def_handle | a default handle corresponding to VA_gen - e.g., one |
| | of “Hey Siri,” “Alexa,” “OK Google,” “Hey Cortana,” |
| | “Hi Bixby,” or the like |
| VA_gen_salute | a salutation, if any, which is included in |
| | VA_def_handle - e.g., one of “Hey,” “OK,” Hi,” or |
| | None (not applicable) |
| VA_gen_name | a proper name which is included in VA_def_handle - |
| | e.g., one of “Siri,” “Alexa,” “Google,” “Cortana,” |
| | “Bixby,” or the like |
| possessive | a predefined suffix, prefix or other grammatical |
| | variation - e.g., “‘s” - to indicate a possession by (or |
| | other relationship with) a corresponding user, device, |
| | or the like |
| ordinal_opt | an ordinal which, optionally, is available to be added - |
| | e.g., to distinguish a “first” voice assistant from a |
| | “second” voice assistant |

In such an embodiment, the generation of a handle based on profile information—such as that in Table 1—includes handle generator 162 applying some or all such profile information to a handle generation template, rule or other such criteria.

By way of illustration and not limitation, Table 2 below shows, for each of various handle templates, a corresponding one or more example handles that may be generated according to that template. The examples shown in Table 2 illustrate various scenarios where the second voice assistant (to be addressed by the first assistant via an utterance from device 150) is operated by a user identified by a user_name of “Jim.” The ellipses (“ . . . ”) in Table 2 indicate one or more words of the sequence—e.g., the one or more other words including a comment, request, or response which is addressed to the second voice assistant.

TABLE 2
Handle Templates and Corresponding Example Handles

| Handle Template | Example Handle(s) |
|---|---|
| <VA_def_handle>. | Hey Siri, . . . |
| <user_name><possessive> voice assistant. | Jim's voice |
| | assistant, . . . |
| <VA_def_handle> on <user_name><possessive> | Hey Siri on Jim's |
| <device_type>. | smartphone, . . . |
| | OK Google on Jim's |
| | smartwatch, . . . |
| <VA_gen_salute> <user_name><possessive> | Jim's Alexa, . . . |
| <VA_gen_name>. | Hey Jim's |
| | Cortana, . . . |
| <VA_gen_salute> <user_name><possessive> | Hi Jim's second |
| <ordinal_opt> <VA_gen_name>. | Bixby, . . . |

Based on a sequence of words which is generated with VA logic 160 (e.g., the sequence including a handle determined by handle generator 162), speech synthesis logic 161 generates audio information which includes a representation of said sequence. Such generating may include operations adapted from conventional speech synthesis techniques (which are not detailed herein to avoid obscuring certain features of various embodiments). Speech synthesis logic 161 provides such audio information to speaker 152 for generation of an utterance from device 150.

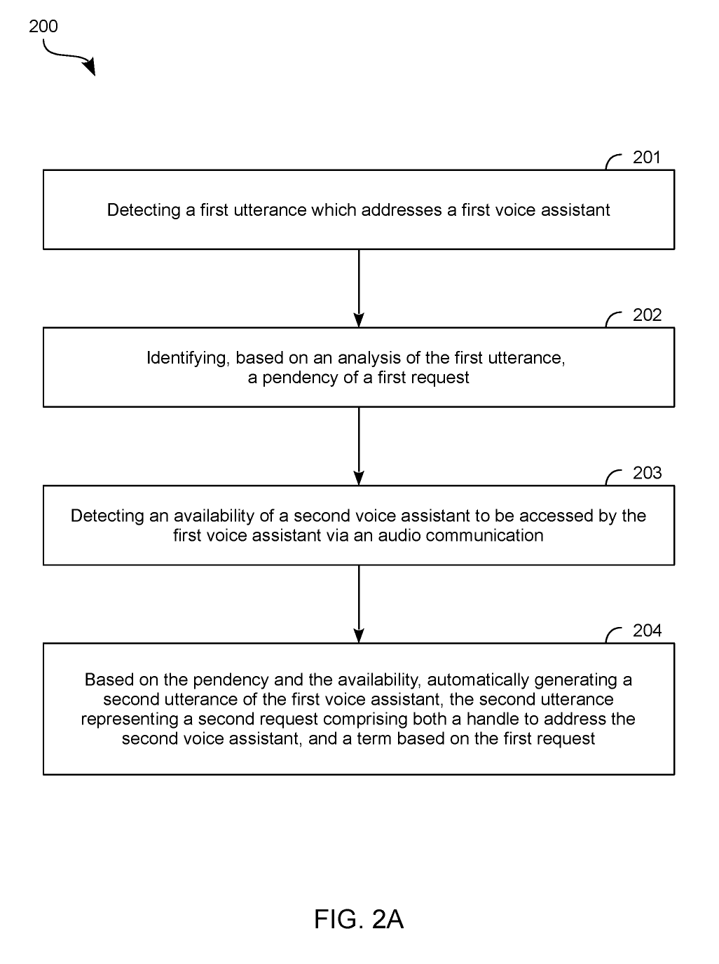

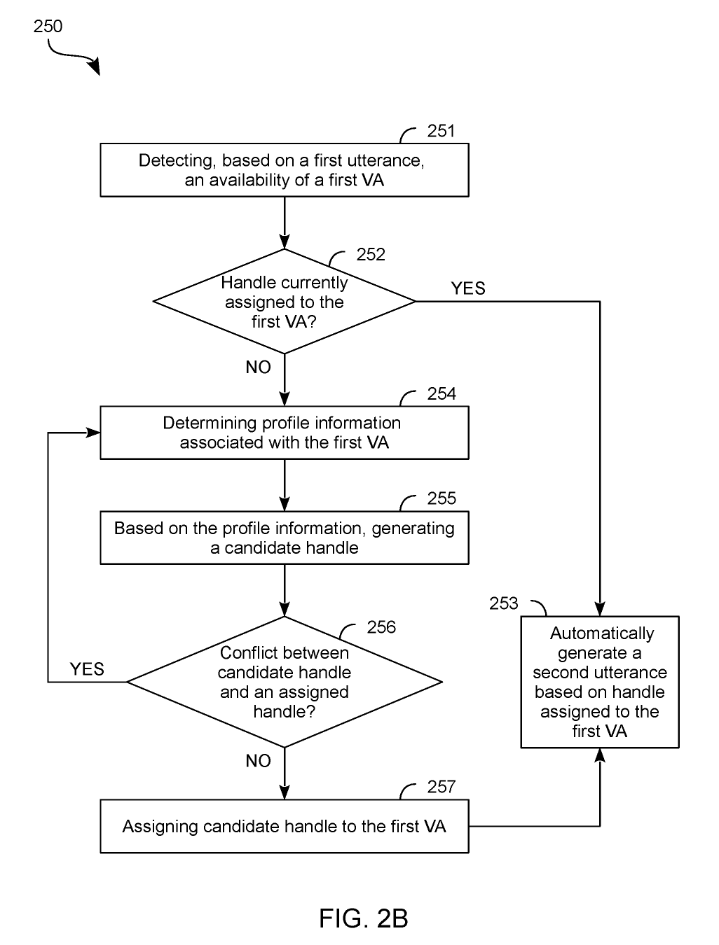

FIG. 2A shows features of a method 200 to communicate with a voice assistant according to an embodiment. Method 200 is one example of an embodiment wherein an utterance is automatically generated so that one voice assistant can address another voice assistant. Method 200 is performed at one of devices 112, 114, 150, for example.

As shown in FIG. 2A, method 200 includes, at 201, detecting a first utterance which addresses a first voice assistant (such as one of voice assistants 114, 124)—e.g., where the detecting at 201 is performed by a device which provides an IO interface of the first voice assistant. In an example embodiment, the detecting at 201 includes voice analysis logic 153 processing audio information received via audio sensor 151—e.g., to identify speech, text and/or other characteristics based on reference information such as rules 159. For example, the detecting at 201 may include identifying that the first utterance includes an instance of a predefined utterance type—e.g., including identifying that the first utterance includes one of a command, a request, or a statement (such as a request response). In one example embodiment, such identifying includes determining that the first utterance comprises a notification that a resource access right is extended to the first voice assistant or, for example, a command for the first voice assistant to extend a resource access right to another voice assistant. In some embodiments, the detecting at 201 includes identifying—e.g., based on a voice pattern of the first utterance—that the first utterance is spoken by a participant in a conversation which is currently underway or, for example, is being initiated by the first utterance.

Method 200 further comprises (at 202) identifying, based on a speech analysis of the first utterance, a pendency of a first request. The identifying may include monitor logic 154 updating QI 158 (or other such conversation state information) to indicate that a request communicated by the first utterance, or by some earlier-in-time utterance, has yet to be followed by any utterance(s) which comprise a satisfactory response to said request. For example, method 200 may include or otherwise be based on monitor logic 154 (or other such hardware and/or software) regularly tracking or otherwise evaluating one or more characteristics of the conversation.

Method 200 further comprises (at 203) detecting an availability of a second voice assistant to be accessed by the first voice assistant via an audio communication. In an example embodiment, the detecting at 203 includes VA logic 160 detecting, based on PI 157 of reference information 155, that the second voice assistant is available as a possible resource for answering the first question at least in part.

Based on the pendency of the first request and the availability of the second voice assistant, method 200 automatically generates (at 204) a second utterance, by the first voice assistant, which represents a second request. The second utterance comprises both a handle to address the second voice assistant, and a term which is based on the first request. In some embodiments, method 200 further comprises operations (not shown) including the first voice assistant asking another participant for permission to pose the second request to the second voice assistant—e.g., where the automatic generating at 204 is further based on the other participant providing such permission.

The term of the second utterance includes or is otherwise based on a search term, a parameter, and/or other information which was included in the first request. In an embodiment, the automatic generating of the second utterance at 204 is independent of any exact recitation of the second request to the first voice assistant. In such an embodiment, a phrasing of the second request is different than a phrasing of the first request, where at least some sequence of words of the second request—e.g., the sequence automatically generated by VA logic 160 (or other such logic)—is different than any sequence of words of the first request.

The automatic generating at 204 includes (for example) generating, searching for, or otherwise determining a handle other than any default handle which corresponds to a voice assistant class/type of the second voice assistant. To avoid possible confusion between the two voice assistants, such an alternative handle is determined, for example, based on a similarity between the first voice assistant and the second voice assistant—e.g., wherein the two voice assistants are each of the same voice assistant class/type. In another embodiment, a handle is determined, for example, based on (and to avoid confusion regarding) a similarity between the respective names of a first user of the first voice assistant and a second user of the second voice assistant. In some embodiments, the handle included in the second utterance is determined based on profile information associated with the second voice assistant—e.g., wherein the second handle includes one of a name of a user, a name of a device type, an ordinal (such as “first,” “second,” or the like), etc.

FIG. 2B shows features of a method 250 to determine a handle for use in a communication between voice assistants according to an embodiment. Method 250 is one example of an embodiment wherein a candidate handle is generated and subsequently assigned to a voice assistant, where such assigning is conditioned upon a determination as to whether there is a conflict between the candidate handle and another handle for another voice assistant. Method 250 is performed at a device (such as one of devices 112, 114, 150) which provides an IO interface of a voice assistant—e.g., where the automatic generating at 204 of method 200 includes, or is otherwise based on, operations of method 250.

As shown in FIG. 2B, method 250 includes (at 251) detecting, based on an utterance, an availability of a first voice assistant (VA). The detecting at 251 may include some or all features of the detecting at 203 of method 200, for example. In an embodiment, the detecting at 251 includes an initial (and at least partial) identification of profile information pertaining to the first voice assistant. Alternatively, the first voice assistant may be previously identified—i.e., prior to the detecting at 251.

Method 250 further comprises (at 252) determining whether a handle is currently assigned to the first voice assistant. In an illustrative embodiment, the determining at 252 includes handle generator 162 (for example) searching PI 157 for any profile information which corresponds to the first voice assistant. Upon an initial detection of a given voice assistant, monitor logic 154 may update PI 157 to include an additional table entry (or other data structure) for storing profile information associated with the first voice assistant. Such a data structure may, over time, be provided with profile information based on a monitoring of conversation state using analysis logic 153 and monitor logic 154.

Where it is determined at 252 that some handle is currently assigned to the first voice assistant, method 250 automatically generates a second utterance (at 253) which is based on said currently-assigned handle. The automatic generating at 253 may include one or more features of the automatic generating at 204, for example. However, where it is instead determined at 252 that no handle is currently assigned to the first voice assistant, method 250 (at 254) determines profile information which is associated with the first voice assistant. In an illustrative embodiment, handle generator 162, or other such logic, accesses profile information PI 157 to determine whether there is sufficient profile information to generate a candidate handle according to a predefined handle template (such as a template of Table 2, for example).

Based on the profile information determined at 254, method 200 generates a candidate handle (255) which is to be considered as a possible handle for use in addressing the first voice assistant. In an embodiment, the generating at 255 includes selecting a handle template from among multiple available handle templates—e.g., where the selecting is based on a determination that sufficient profile information has been determined at 254 to use the handle template.

Subsequently, method 250 may determine (at 256) whether there is a conflict between the candidate handle and another handle (if any) which is currently assigned to some other voice assistant. In an embodiment, the determining at 256 includes detecting a similarity of the candidate handle to an already assigned handle—e.g., where the handles both include the same user_name string, the same device_type string, and/or the same VA_gen string.

Where it is determined at 256 that there is a conflict between the candidate handle and some other, currently-assigned handle, method 250 may perform another sequence of operations to generate and evaluate a different candidate handle for the first voice assistant—e.g., wherein method 250 performs another determining (at 254) of different profile information to be used for generating the different candidate handle. Where it is instead determined at 256 that there is no such conflict with the candidate handle, method 250 may assign the candidate handle to the first voice assistant (at 257) and—subsequently—generate an utterance (at 253) which is based on the handle assigned to the first voice assistant.

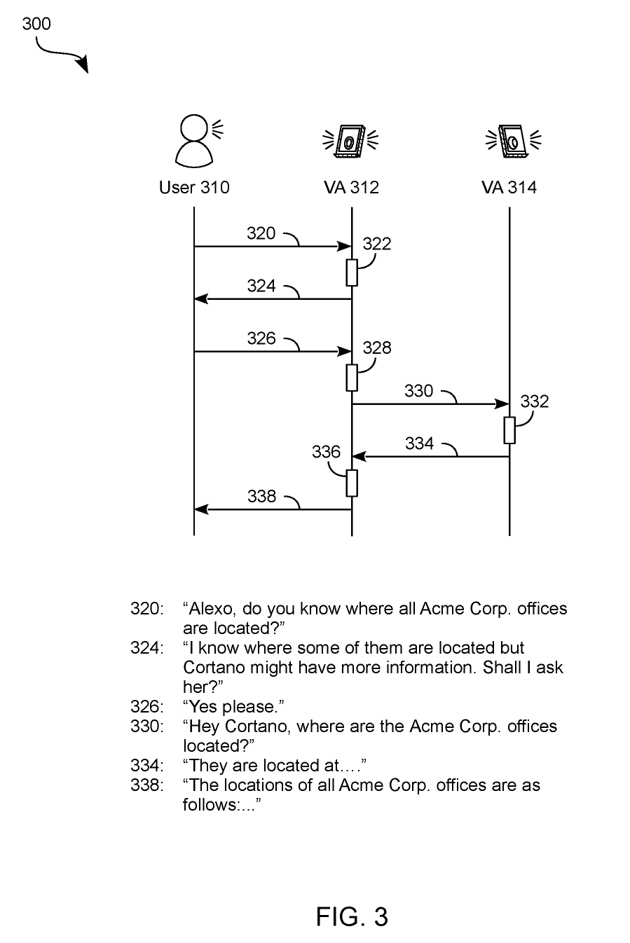

FIG. 3 shows features of an audio communication exchange 300 which includes an utterance generated by a voice assistant according to an embodiment. Communication exchange 300 illustrates an example embodiment wherein one voice assistant automatically generates a question to pose to another voice assistant. Communication exchange 300 may include or otherwise be based on the generation of an utterance according to method 200—e.g., where the generation is performed with one of devices 112, 122, 150.

As shown in FIG. 3, communication exchange 300 involves a user 310 who is authorized to interact with two voice assistants VAs 312, 314. For example, user 310 may be an owner or other authorized user of devices which each implement, or otherwise provide access to, a different respective one of VAs 312, 314. In the example shown, a first voice assistant type of VA 312 is different than a second voice assistant type of VA 314—e.g., wherein the first voice assistant type and the second voice assistant type correspond, respectively, to pre-defined generic handles “Alexa” and “Cortano.”

In the example scenario, user 310 communicates to VA 312 some audible information request 320—e.g., to determine where all offices of a particular business (“Acme Corp.”) are located. To service request 320, processing 322 may be performed with (or otherwise on behalf of) VA 312. For example, the device which executes or otherwise provides VA 312 may access data search resources (e.g., local to that device or available via a network) in an attempt to determine an answer for request 320. The device may additionally or alternatively perform an evaluation as to whether, according to some pre-defined criteria, a result of any such data search is to be considered sufficient for answering request 320.

In an embodiment, processing 322 determines a possibility of utilizing VA 314 to provide an answer to request 320. Such determining may include identifying an availability of VA 314 to be accessed by VA 312 via audio communication. Such determining may also include identifying—e.g., based on a VA type of VA 314—that VA 314 has access to at least some data search resources other than any which are available to VA 312. Based on processing 322, VA 312 may prepare to generate an audio request for access to such data search resources.

For example, speech synthesis logic of VA 312 may output another audio request 324 for user 310 to authorize use of VA 314 in servicing request 320. In some embodiments, VA 312 may forego request 324—e.g., where VA 312 has been previously provided with such authorization and/or where VA 314 itself is to be asked for such authorization. Where user 310 gives the requested authorization—e.g., in an audible response 326—processing 328 may be performed to automatically generate an utterance (such as the illustrative request 330 shown) to ask VA 314 for at least some information which facilitates an answer to request 320.

Generation of request 330 with VA 312 may be automatic at least insofar as at least some phrasing of request 330 differs from that of request 320, where such difference is provided independent of any explicit instruction by user 310 regarding the difference. In one embodiment, generation of request 330 includes or is otherwise based on processing 328 determining the second VA type of VA 314 and a handle (e.g., one of “Cortano,” “Hey, Cortano” or the like) which corresponds to said voice assistant type. Such a handle may be provided at a beginning of request 330. Alternatively or in addition, generation of request 330 may include determining a phrasing an inquiry portion of request 330—e.g., wherein such an inquiry portion is based on an inquiry portion of request 320. For example, request 330 may include an abbreviated, redacted, rephrased or otherwise modified version of words in request 320 (e.g., wherein “where are the Acme Corp. offices located” is included instead of “do you know where all Acme Corp. offices are located”). Based on request 330, processing 332 may be performed with (or otherwise on behalf of) VA 314—e.g., where such processing 332 generates an audible response 334. In turn, VA 312 may perform additional processing to provide—based on response 334—an audible response to request 320. For example, processing 336 is further performed by VA 312 to intelligently generate an uttered response 338 to request 320, where response 328 is based at least in part on—e.g., which includes information communicated with—the uttered response 334 from VA 314. In one such embodiment, response 338 represents a combination of information provided by VA 314 and other information which VA 312 retrieves from some other database, server or other such resource.

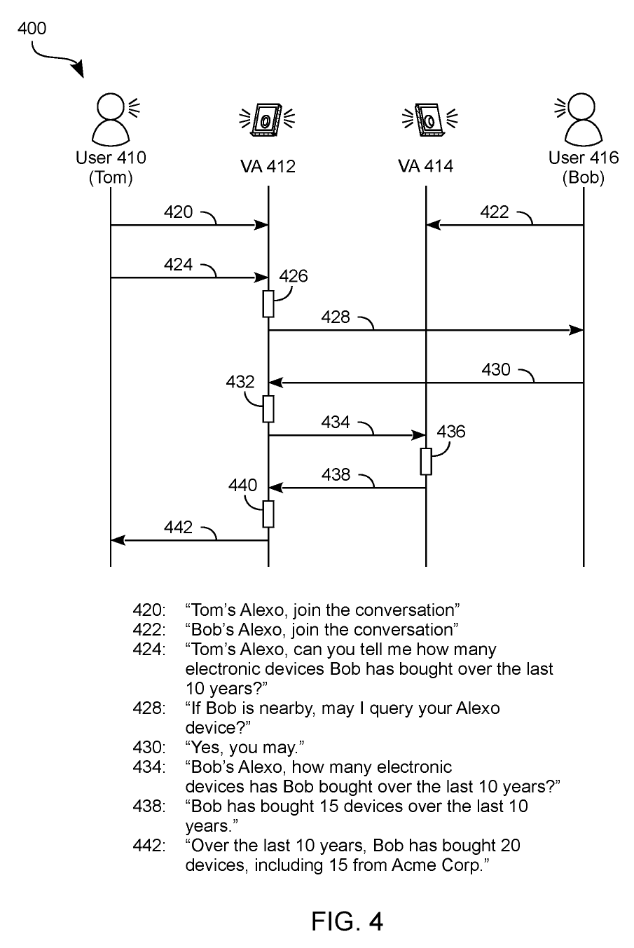

FIG. 4 shows features of an audio communication exchange 400 which includes an utterance generated by a voice assistant according to an embodiment. Communication exchange 400 may include or otherwise be based on the generation of an utterance according to method 200, for example. To avoid obscuring certain features of various embodiments, exchange 400 is shown as having some features similar to those of exchange 300—e.g., wherein requests 424, 428, 434 of exchange 400 are variously similar to respective requests 320, 324, 330. Furthermore, responses 430, 438 of exchange 400 are variously similar to respective responses 326, 334, wherein processing 426, processing 432, and processing 436 of exchange 400 are variously similar to processing 322, processing 328, and processing 332 (respectively). However, additional and/or alternative communications may be provided by one of more VAs in exchange 400 according to various embodiments.

As shown in FIG. 4, communication exchange 400 involves a user 410, with the name “Tom,” who is authorized to interact with a voice assistant VA 412. Communication exchange 500 also involves another user 416, with the name “Bob,” who is authorized to interact with a voice assistant VA 414. For example, VA 412 may be implemented with a device which authorizes access to user 410, where VA 414 is implemented with another device which authorizes access to user 416. In the example shown, each of VAs 412, 414 is of a voice assistant type which corresponds to a pre-defined generic handle (in this example, “Alexo”).

To avoid possible confusion regarding this handle, one or both of VAs 412, 414 may be configured—e.g., reconfigured—to respond each to some respective alternative handle. By way of illustration and not limitation, VAs 412 may instead respond to the handle “Tom's Alexo” and/or VAs 414 may respond to the handle “Bob's Alexo.” Such (re)configuration of a voice assistant to recognize an alternative handle (and/or the user of an alternative handle for another VA) may be performed automatically by the voice assistant—e.g., based on conversation state information which is determined with the voice assistant.

In the example scenario, exchange 400 includes requests 420, 422 from users 410, 416 for VAs 412, 414 (respectively) to join a conversation involving users 410, 416. Alternatively, exchange 400 may omit one or both of requests 420, 422—e.g., wherein VA 412 (for example) is pre-configured to automatically join a conversation in response to an utterance from user 410, any utterance which addresses “Tom” and/or any of a variety of other possible predefined trigger events.

Subsequently, user 410 may communicate to VA 412 some audible information request 424—e.g., to determine how many electronic devices user 416 has bought in the last ten years. To service request 424, processing 426 may be performed with (or otherwise on behalf of) VA 412—e.g., wherein such processing 426 includes features of processing 322. Processing 426 may determine a possibility of utilizing VA 414 to provide an answer to request 424. For example, processing 426 may determine that VA 414 is available via audio communication, and may further determine that, as compared to VA 412, VA 414 is likely to have access to more detailed information regarding user 416. Based on processing 426, VA 412 may prepare to generate an audio request for access to data via VA 414. For example, speech synthesis logic of VA 412 may output another audio request 428 for user 416 to authorize access to VA 414. Alternatively, VA 412 may already have such authorization and/or VA 414 may be asked for such authorization directly. Where user 416 gives the requested authorization—e.g., in an audible response 430—processing 432 may be performed to automatically utter a request 434 for VA 414 to provide information which facilitates an answer to request 424.

Similar to request 330, the phrasing of an inquiry portion of request 434 (e.g., a portion other than the handle portion “Bob's Alexo”) may be different than a phrasing of an inquiry portion of request 424. This different phrasing may be provided automatically by processing 432—e.g., independent of any explicit instruction by user 410 regarding the difference. Based on request 434, processing 436 may be performed with (or otherwise on behalf of) VA 414—e.g., where such processing 436 generates an audible response 438 to request 434. In turn, VA 412 may perform additional processing to provide—based on response 438—an audible response to request 424. For example, processing 440 is further performed by VA 412 to intelligently generate an uttered response 442 to request 424, where response 442 is based at least in part on—e.g., which includes information communicated with—the uttered response 438 from VA 414. In one such embodiment, response 442 represents a combination of information provided by VA 414 and other information which VA 412 retrieves from some other database, server or other such resource.

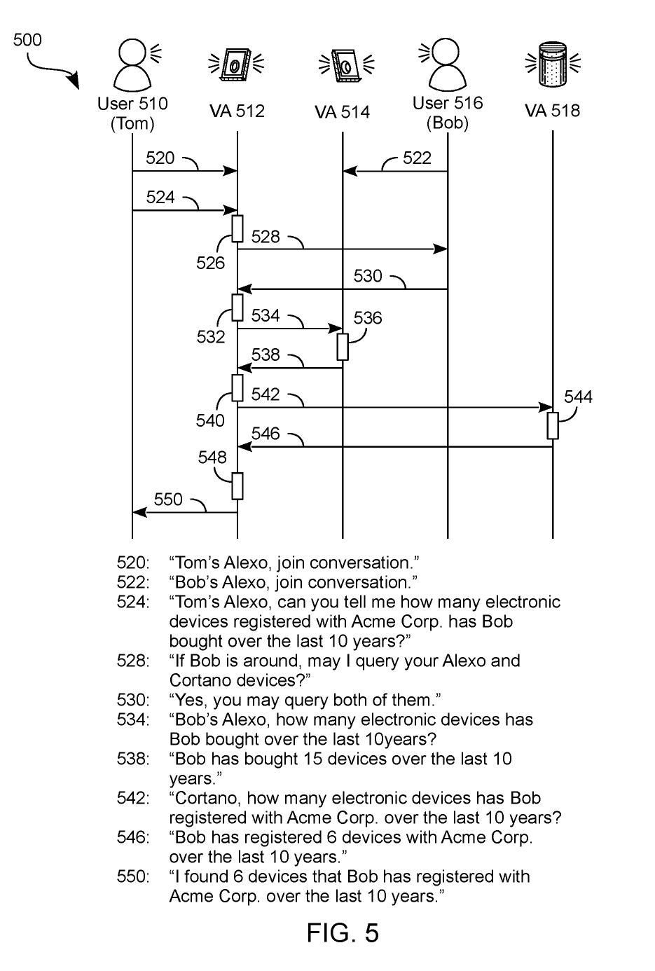

FIG. 5 shows features of an audio communication exchange 500 which includes an utterance generated by a voice assistant according to an embodiment. Communication exchange 500 may include or otherwise be based on the generation of an utterance according to method 200—e.g., where the generation is performed with one of devices 112, 122, 150. Exchange 500 is shown as having features similar to those of exchange 400—e.g., wherein requests 520, 522, 524, 528, 534 of exchange 500 correspond to respective requests 420, 422, 424, 428, 434. Furthermore, responses 530, 538 of exchange 500 correspond to respective responses 430, 438, wherein processing 526, processing 532, and processing 536 of exchange 500 correspond to processing 426, processing 432, and processing 436 (respectively). However, additional and/or alternative communications may be provided by one of more VAs in exchange 500 according to various embodiments.

As shown in FIG. 5, communication exchange 500 involves a user 510 (named “Tom”) who is authorized to interact with a voice assistant VA 512. Communication exchange 500 also involves another user 516 (named “Bob”) who is authorized to interact with two voice assistants VA 514 and VA 518. In this example scenario, each of VAs 512, 514 is of a first voice assistant type which corresponds to a first pre-defined generic handle “Alexo.” By contrast, VA 518 is of a second voice assistant type which corresponds to a second pre-defined generic handle “Cortano.”

Similar to VAs 412, 414, some or all of VAs 512, 514, 518 may be configured to respond each to some respective alternative handle. By way of illustration and not limitation, VA 512 may instead respond to the handle “Tom's Alexo” and/or VA 514 may respond to the handle “Bob's Alexo.” Alternatively or in addition, VA 518 may respond to “Bob's Cortano,” although (in the scenario shown) VA 518 may be addressed with merely “Cortano” if communication exchange 500 does not also involve any other VAs of the second voice assistant type. In an embodiment, VA 512 and/or VA 518 may be able to automatically detect—e.g., based on conversation state information—that “Cortano” is available for use in addressing VA 518 without ambiguity as to any other voice assistant in the conversation.

In the example scenario shown, VA 512 outputs audio request 528 for user 516 to authorize access to both VA 514 and VA 518. Where user 516 gives the requested authorization—e.g., in an audible response 530—processing 532 is performed to generate a request 534 for VA 514 to provide information which facilitates an answer to request 524. Based on request 534, processing 536 may be performed with (or otherwise on behalf of) VA 514—e.g., where such processing 536 generates an audible response 538 to request 534.

Although some embodiments are not limited in this regard, additional processing 540 with VA 512 may be performed—e.g., based on response 538—to generate another audible request 542 for VA 518 to provide additional information for answering request 524. For example, VA 512 may determine (based on conversation state information) a possibility that VA 518 has more particular information about whether user 516 has registered any devices with Acme Corp. Such a determination may be based, for example, on Acme Corp. having a particular relationship—e.g., as developer, owner, manager or the like—with a voice assistant service type to which VA 518 belongs. Based on request 542, processing 544 may be performed with (or otherwise on behalf of) VA 518—e.g., where such processing 544 generates an audible response 546 to request 542. In turn, VA 512 may perform additional processing to provide—based on one or both of responses 538, 546—an audible response to request 524. For example, processing 548 is further performed by VA 512 to intelligently generate an uttered response 550 to request 524, where response 550 is based at least in part on—e.g., which includes information communicated with—the uttered response 546 from VA 518. In one such embodiment, response 550 represents a combination of information provided by VA 514 and other information which VA 512 retrieves from some other database, server or other such resource.

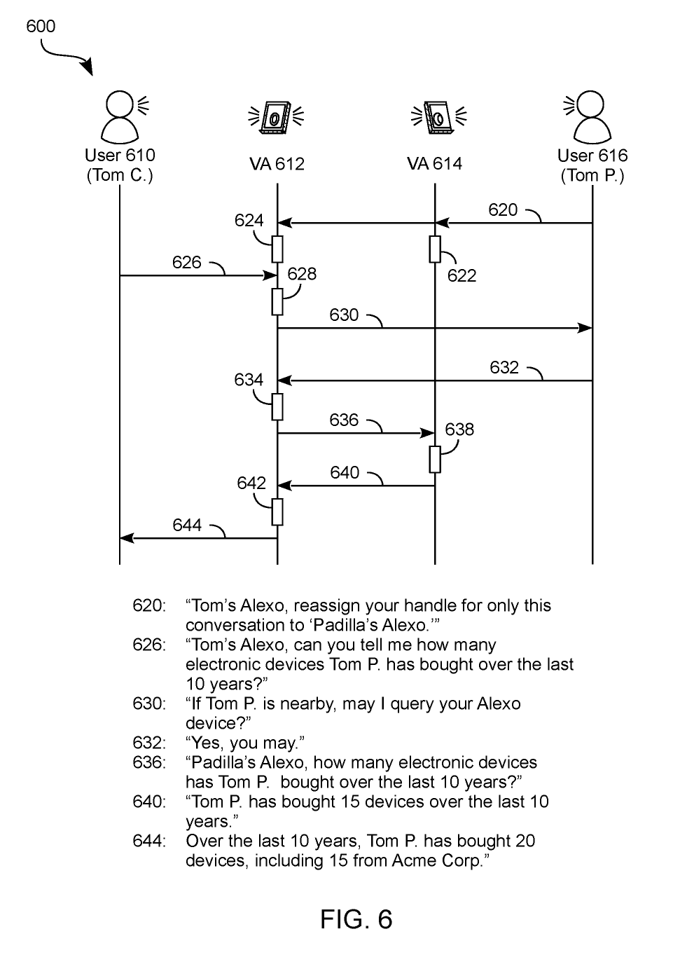

FIG. 6 shows features of an audio communication exchange 600 which includes an utterance generated by a voice assistant according to an embodiment. Communication exchange 600 may include or otherwise be based on the generation of an utterance according to method 200—e.g., where the generation is performed with one of devices 112, 122, 150. Exchange 600 is shown as having features similar to those of exchange 400—e.g., wherein requests 626, 630, 636 of exchange 600 correspond to respective requests 424, 428, 434. Furthermore, responses 632, 640 of exchange 600 correspond to respective responses 430, 438, wherein processing 628, processing 634, and processing 638 of exchange 600 correspond to processing 426, processing 432, and processing 436 (respectively). Additional and/or alternative communications may be provided by one of more VAs in exchange 600 according to various embodiments.

As shown in FIG. 6, communication exchange 600 involves a user 610 (with the name “Tom C.”) who is authorized to interact with a voice assistant VA 612. Communication exchange 600 also involves another user 616 (with the name “Tom P.”) who is authorized to interact with another voice assistant VA 614. In this example scenario, each of VAs 612, 614 is of a voice assistant type which corresponds to a pre-defined generic handle “Alexo.” This same voice assistant type may lead to confusion as to which of VAs 612, 614 is being addressed by a given utterance. To avoid such confusion, one or both of VAs 612, 614 may automatically use an alternative handle to address the respective other VA, and/or may respond to another such alternative handle. However, VAs 612, 614 may choose the same alternative handle in some situation—e.g., where “Tom's Alexo” could be applicable for either of VAs 612, 614. To avoid this possibility, VAs 612, 614 may automatically operate—individually or via audio communications with each other—to agree upon, or otherwise facilitate the use of, respective handles which are sufficiently distinct from one another.

Alternatively or in addition, a user may explicitly assign an alternative handle to one of VAs 612, 614. For example, an utterance 620 from user 616 may instruct VA 614 to respond to an alternative handle (in this example, “Padilla's Alexo”). Responsive to utterance 620, processing 622 may reconfigure VA 614 to be responsive to this alternative handle. In some embodiments, VA 612 may overhear an audio communication such as utterance 620 and—in response—perform processing 624 which configures the use of “Padilla's Alexo” to address VA 614 in a future utterance (if any). For example, this alternative handle may be used in the audible request 636 for information from VA 614. Based on request 636, processing 638 may be performed with (or otherwise on behalf of) VA 614—e.g., where such processing 638 generates an audible response 640 to request 636. In turn, VA 612 may perform additional processing to provide, based on response 640, an audible response to request 626. For example, processing 642 is further performed by VA 612 to intelligently generate an uttered response 644 to request 626, where response 644 is based at least in part on—e.g., which includes information communicated with—the uttered response 640 from VA 614. In one such embodiment, response 644 represents a combination of information provided by VA 614 and other information which VA 612 retrieves from some other database, server or other such resource.

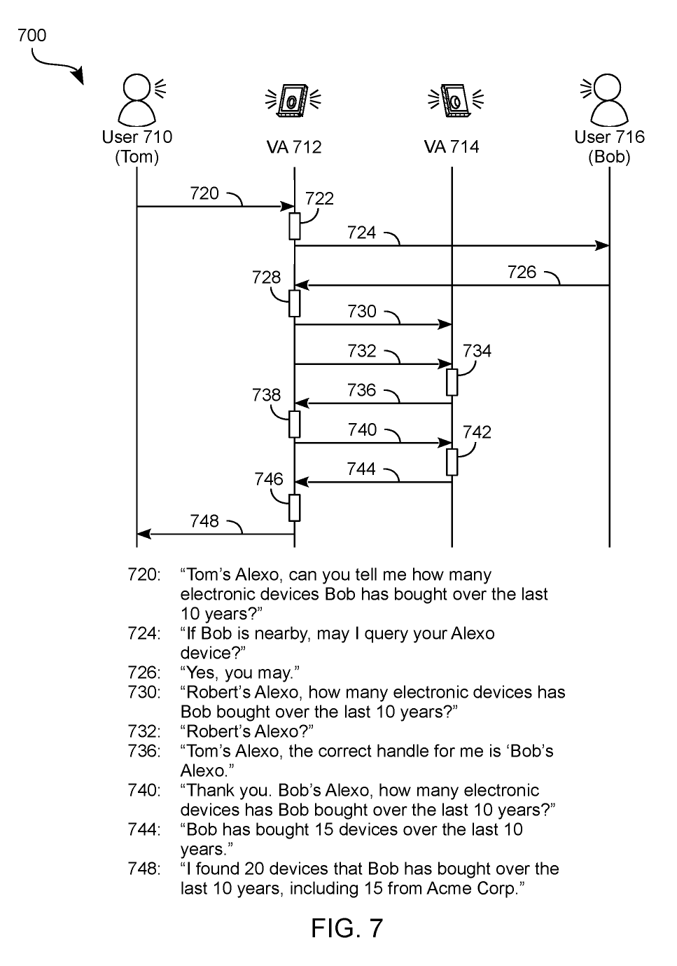

FIG. 7 shows features of an audio communication exchange 700 which includes an utterance generated by a voice assistant according to an embodiment. Communication exchange 700 may include or otherwise be based on the generation of an utterance according to method 200, for example. Exchange 700 is shown as having some features similar to those of exchange 400—e.g., wherein requests 720, 724, 740 of exchange 700 are variously similar to respective requests 424, 428, 434. Furthermore, responses 726, 744 of exchange 700 are variously similar to respective responses 430, 438, wherein processing 722, processing 728, and processing 742 of exchange 700 are variously similar to processing 426, processing 432, and processing 436 (respectively). However, additional and/or alternative communications may be provided by one of more VAs during exchange 700 according to various embodiments.

As shown in FIG. 7, communication exchange 700 involves users 710, 716 (named “Tom” and “Bob”) who are authorized to interact with respective voice assistants VA 712 and VA 714. In the example shown, each of VAs 712, 714 is of a voice assistant type which corresponds to a pre-defined generic handle (e.g., “Alexo”). To avoid possible confusion regarding this handle, one or both of VAs 712, 714 may be configured to respond each to some respective alternative handle. During exchange 700, one of VAs 712, 714 may be configured to use an incorrect handle for the other of VAs 712, 714. For example, VA 712 may be configured to refer to VA 714 with the handle “Robert's Alexo,” rather than another handle (e.g., “Bob's Alexo”) which VA 714 is configured to recognize.

In such a situation, processing 728 may be performed to automatically utter a request 730 for VA 714 to provide information which facilitates an answer to request 720. However, since request 730 includes the incorrect handle “Robert's Alexo,” VA 714 may forego any response to request 730. Although some embodiments are not limited in this regard, VA 712 may output another utterance 732 which, for example, repeats the unanswered request 730 (or otherwise attempts to contact VA 714). Analysis processing 734 performed by (or on behalf of) VA 714 may detect—based on one or both of utterances 730, 732—that VA 712 is attempting to address VA 714. In response to such detecting, VA 714 may output an utterance 736 to inform VA 712 of the correct handle “Bob's Alexo,” whereupon processing 738 may be performed to configure VA 712 for use of this correct handle. Based on processing 728, VA 712 may automatically utter a request 740 as a modified version of request 730. To service request 740, processing 742 may be performed with (or otherwise on behalf of) VA 714—e.g., where such processing 742 generates an audible response 744 to request 740. In turn, VA 712 may perform additional processing to provide—based on response 744—an audible response to request 720. For example, processing 746 is further performed by VA 712 to intelligently generate an uttered response 748 to request 720, where response 748 is based at least in part on—e.g., which includes information communicated with—the uttered response 744 from VA 714. In one such embodiment, response 748 represents a combination of information provided by VA 714 and other information which VA 712 retrieves from some other database, server or other such resource.

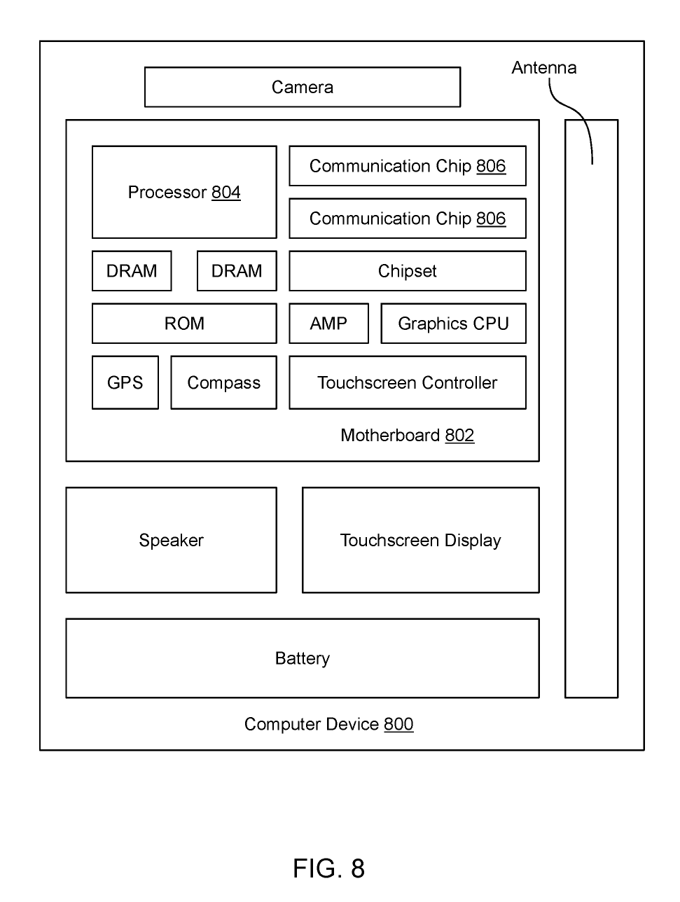

FIG. 8 illustrates a computing device 800 in accordance with one embodiment. The computing device 800 houses a board 802. The board 802 may include a number of components, including but not limited to a processor 804 and at least one communication chip 806. The processor 804 is physically and electrically coupled to the board 802. In some implementations the at least one communication chip 806 is also physically and electrically coupled to the board 802. In further implementations, the communication chip 806 is part of the processor 804.

Depending on its applications, computing device 800 may include other components that may or may not be physically and electrically coupled to the board 802. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 806 enables wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 806 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

The processor 804 of the computing device 800 includes an integrated circuit die packaged within the processor 804. The term “processor” may refer to any device or portion of a device that processes electronic data from registers and/or memory to transform that electronic data into other electronic data that may be stored in registers and/or memory. The communication chip 806 also includes an integrated circuit die packaged within the communication chip 806.

In various implementations, the computing device 800 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 800 may be any other electronic device that processes data.

Some embodiments may be provided as a computer program product, or software, that may include a machine-readable medium having stored thereon instructions, which may be used to program a computer system (or other electronic devices) to perform a process according to an embodiment. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

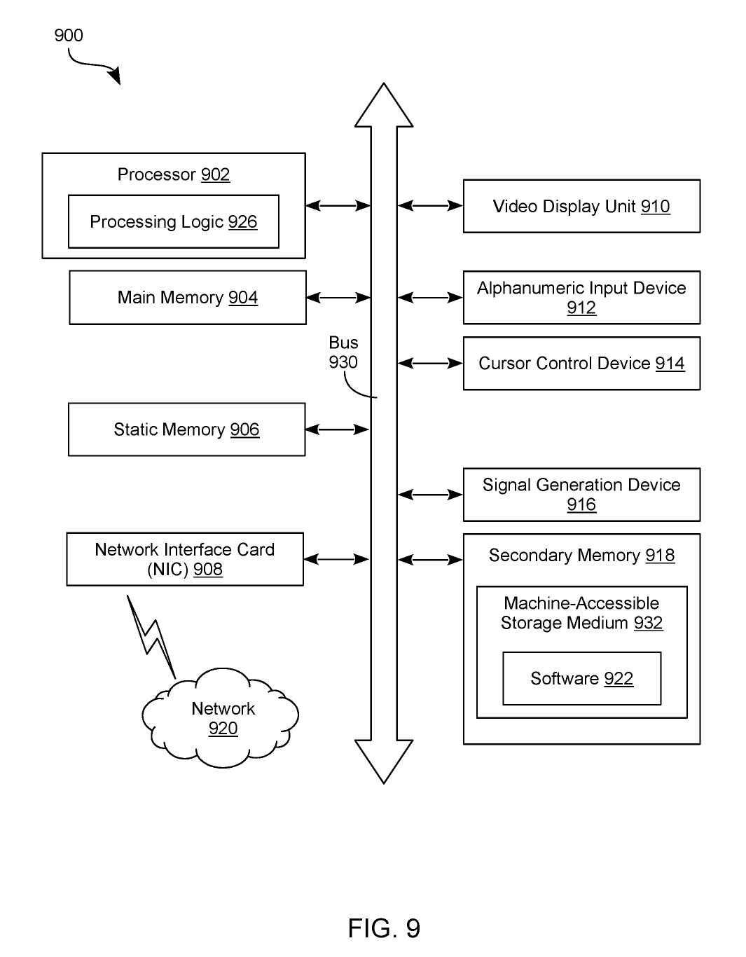

FIG. 9 illustrates a diagrammatic representation of a machine in the exemplary form of a computer system 900 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 900 includes a processor 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a secondary memory 918 (e.g., a data storage device), which communicate with each other via a bus 930.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 902 may also be one or more special-purpose processing devices such as an application specific integrated circuit (ASIC), a field programmable gate array (FPGA), a digital signal processor (DSP), network processor, or the like. Processor 902 is configured to execute the processing logic 926 for performing the operations described herein.

The computer system 900 may further include a network interface device 908. The computer system 900 also may include a video display unit 910 (e.g., a liquid crystal display (LCD), a light emitting diode display (LED), or a cathode ray tube (CRT)), an alphanumeric input device 912 (e.g., a keyboard), a cursor control device 914 (e.g., a mouse), and a signal generation device 916 (e.g., a speaker).

The secondary memory 918 may include a machine-accessible storage medium (or more specifically a computer-readable storage medium) 932 on which is stored one or more sets of instructions (e.g., software 922) embodying any one or more of the methodologies or functions described herein. The software 922 may also reside, completely or at least partially, within the main memory 904 and/or within the processor 902 during execution thereof by the computer system 900, the main memory 904 and the processor 902 also constituting machine-readable storage media. The software 922 may further be transmitted or received over a network 920 via the network interface device 908.

While the machine-accessible storage medium 932 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any of one or more embodiments. The term “machine-readable storage medium” shall accordingly be taken to include, but not be limited to, solid-state memories, and optical and magnetic media.

Techniques and architectures for audio communication with a voice assistant are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device for communicating with a voice assistant, the device comprising:
first circuitry to detect a first utterance which addresses a first voice assistant and to identify, based on an analysis of the first utterance, a pendency of a first request;
second circuitry to detect an availability of a second voice assistant to be accessed by the first voice assistant via an audio communication; and
third circuitry, coupled to the first circuitry and the second circuitry, to automatically generate a second utterance of the first voice assistant based on the pendency of the first request and the availability of the second voice assistant, the second utterance to represent a second request comprising both a handle to address the second voice assistant, and a term based on the first request.

2. The device of claim 1, wherein a phrasing of the second request is different than a phrasing of the first request.

3. The device of claim 1, wherein a voice assistant type of the second voice assistant corresponds to a default handle other than the handle to address the second voice assistant.

4. The device of claim 3, wherein the handle to address the second voice assistant comprises one of a salutation of the default handle or a proper name of the default handle.

5. The device of claim 1, wherein the handle to address the second voice assistant indicates a device type of a device which provides an input and/or output (IO) interface of the second voice assistant.

6. The device of claim 1, wherein the handle to address the second voice assistant indicates a name of a user of the second voice assistant.

7. The device of claim 1, further comprising fourth circuitry to determine the handle to address the second voice assistant, wherein the fourth circuitry is to:
determine profile information associated with the second voice assistant;
generate a candidate handle based on the profile information; and
detect for a conflict between the candidate handle and a handle assigned to another voice assistant.

8. The device of claim 7, wherein the fourth circuitry to detect for the conflict comprises one of:
the fourth circuitry to detect whether the first voice assistant and the second voice assistant each belong to a same voice assistant type; or
the fourth circuitry to detect for a similarity between respective names of a first user of the first voice assistant and a second user of the second voice assistant.

9. The device of claim 1, further comprising:
fifth circuitry to automatically generate a third utterance of the first voice assistant prior to the second utterance, the third utterance to request permission to communicate the second request to the second voice assistant, wherein the fourth circuitry to automatically generate the second utterance is responsive to a granting of the permission.

10. The device of claim 1, wherein:
the first circuitry is further to detect a third utterance by the second voice assistant; and
the third circuitry is further to automatically generate a fourth utterance based on information communicated by the third utterance, wherein the fourth utterance comprises a response to the first request.

11. One or more non-transitory computer-readable storage media having stored thereon instructions which, when executed by one or more processing units, cause the one or more processing units to perform a method for communicating with a voice assistant, the method comprising:
detecting a first utterance which addresses a first voice assistant;
identifying, based on an analysis of the first utterance, a pendency of a first request;
detecting an availability of a second voice assistant to be accessed by the first voice assistant via an audio communication; and
based on the pendency of the first request and the availability of the second voice assistant, automatically generating a second utterance of the first voice assistant, the second utterance representing a second request comprising both a handle to address the second voice assistant, and a term based on the first request.

12. The one or more non-transitory computer-readable storage media of claim 11, wherein a phrasing of the second request is different than a phrasing of the first request.

13. The one or more non-transitory computer-readable storage media of claim 11, wherein a voice assistant type of the second voice assistant corresponds to a default handle other than the handle to address the second voice assistant.

14. The one or more non-transitory computer-readable storage media of claim 11, wherein the handle to address the second voice assistant indicates one of:
a device type of a device which provides an input and/or output (IO) interface of the second voice assistant; or
a name of a user of the second voice assistant.

15. The one or more non-transitory computer-readable storage media of claim 11, the method further comprising determining the handle to address the second voice assistant, comprising:
determining profile information associated with the second voice assistant;
generating a candidate handle based on the profile information;
detecting for a conflict between the candidate handle and a handle assigned to another voice assistant; and
based on the detecting for the conflict:
assigning the candidate handle to the second voice assistant; or
generating another candidate handle based on the profile information.

16. The one or more non-transitory computer-readable storage media of claim 11, the method further comprising determining the handle to address the second voice assistant, comprising:
detecting a third utterance by the second voice assistant; and
automatically generating a fourth utterance based on information communicated by the third utterance, wherein the fourth utterance comprises a response to the first request.

17. A computer-implemented method for communicating with a voice assistant, the method comprising:
detecting a first utterance which addresses a first voice assistant;
identifying, based on an analysis of the first utterance, a pendency of a first request;
detecting an availability of a second voice assistant to be accessed by the first voice assistant via an audio communication; and
based on the pendency of the first request and the availability of the second voice assistant, automatically generating a second utterance of the first voice assistant, the second utterance representing a second request comprising both a handle to address the second voice assistant, and a term based on the first request.

18. The method of claim 17, wherein the handle to address the second voice assistant indicates a device type of a device which provides an input and/or output (IO) interface of the second voice assistant.

19. The method of claim 17, wherein the handle to address the second voice assistant indicates a name of a user of the second voice assistant.

20. The method of claim 17, further comprising determining the handle to address the second voice assistant, comprising:
determining profile information associated with the second voice assistant;
generating a candidate handle based on the profile information;
detecting for a conflict between the candidate handle and a handle assigned to another voice assistant; and
based on the detecting for the conflict:
assigning the candidate handle to the second voice assistant; or
generating another candidate handle based on the profile information.

21. A system for communicating with a voice assistant, the system comprising:
a circuit device comprising:
first circuitry to detect a first utterance which addresses a first voice assistant and to identify, based on an analysis of the first utterance, a pendency of a first request;
second circuitry to detect an availability of a second voice assistant to be accessed by the first voice assistant via an audio communication; and
third circuitry, coupled to the first circuitry and the second circuitry, to automatically generate a second utterance of the first voice assistant based on the pendency of the first request and the availability of the second voice assistant, the second utterance to represent a second request comprising both a handle to address the second voice assistant, and a term based on the first request; and
a display device coupled to the circuit device, the display device to display an image based on a signal from the first voice assistant.

22. The system of claim 21, wherein a phrasing of the second request is different than a phrasing of the first request.

23. The system of claim 21, wherein a voice assistant type of the second voice assistant corresponds to a default handle other than the handle to address the second voice assistant.

24. The system of claim 21, wherein the handle to address the second voice assistant indicates one of:
a device type of a second device which provides an input and/or output (IO) interface of the second voice assistant; or
a name of a user of the second voice assistant.
